(19) United States
(12) Patent Application Publication
(10) Pub. No.: US 2013/0037120 A1
(43) Pub. Date: Feb. 14, 2013

(54) METHOD FOR THE COMPRESSION OF BOIL-OFF GAS

(71) Applicant: Heinz BAUER, Ebenhausen (DE)

(72) Inventor: Heinz BAUER, Ebenhausen (DE)

(73) Assignee: LINDE AKTIENGESELLSCHAFT, Munchen (DE)

(21) Appl. No.: 13/570,302

(22) Filed: Aug. 9, 2012

(30) Foreign Application Priority Data
Aug. 11, 2011 (DE) 102011110004.4

(51) Int. Cl. F17D 1/16

(52) U.S. Cl. 137/14

(57) ABSTRACT

The invention relates to a method for compression of boil-off gas produced in the storage of liquefied natural gas (LNG), in which the boil-off gas is compressed in a single-stage or multistage manner and then fed to a further use. The boil-off gas (1) that is to be compressed undergoes a pressure elevation by means of at least one ejector (Y) and then warmed (E2), before being compressed (V) in a single-stage or multistage manner> The motive gas (2) used for the ejector (Y) is a substream of the compressed boil-off gas and/or a gas, the composition of which is substantially identical to or similar to that of the boil-off gas (1) and/or the addition of which to the boil-off gas does not adversely affect the intended use of the compressed boil-off gas.

### SUMMARY OF THE INVENTION

The invention relates to a method for the compression of boil-off gas that is produced in the storage of liquefied natural gas (LNG), wherein the boil-off gas is compressed in a single-stage or multistage manner and then fed to a further use.

Liquefied natural gas (LNG) is usually stored in flat-bottomed tanks from a storage volume of approximately 3000 m³. These are operated at a pressure slightly above atmospheric pressure, preferably at 100 to 200 mbar gauge pressure. Gases produced in these tanks, in particular end-flash gases, boil-off gases, tank-return gases, are usually compressed for further use, for example as fuel gas, or, after compression thereof, are returned to the natural gas that is to be liquefied. In the simplest case this compression is performed using a cold-intake compressor which operates directly at tank pressure. The expression “boil-off gas” hereinafter will be taken to mean all gases which collect above the liquefied natural gas in the gas space of a (LNG) tank.

If it is wished to avoid the solution involving compression is performed using a cold-intake compressor, because of the associated low operating temperature of the cold-intake compressor—the storage of LNG proceeds at approximately −160° C.—the boil-off gas that is to be compressed is warmed before it is compressed by a warm-intake compressor. In order to be able to compensate for the pressure drop in the heater, the pipelines, etc., a cold-intake fan is connected upstream of the heater. This cold-intake fan compensates for the pressure drop in such a manner that vacuum can reliably be avoided on the compressor suction side at the risk of oxygen ingress into a flammable gas. Such a procedure is described, for example, in U.S. Pat. No. 6,658,892.

However, all the modes of operation known from the prior art require a cold-intake machine—that is to say either a cold-intake compressor or a cold-intake fan—or, if a cold-intake fan is dispensed with, are accompanied by the increased risk of operating the method on the suction side of a warm-intake compressor, at least at times, under hazardous reduced-pressure conditions.

Therefore, an aspect of the present invention is to specify a method of the type in question for the compression of boil-off gas produced in the storage of liquefied natural gas, which method avoids the abovementioned disadvantages, and in particular makes possible a safe compression of boil-off gas without use of a cold-intake machine.

Upon further study of the specification and appended claims, other aspects and advantages of the invention will become apparent.

To achieve these objects, a method is provided for the compression of boil-off gas produced in the storage of liquefied natural gas, which method is characterized in that the boil-off gas that is to be compressed undergoes a pressure elevation by means of at least one ejector, is warmed and compressed in a single-stage or multistage manner. The motive gas used for the ejector is a substream of the compressed boil-off gas and/or a gas, the composition of which is substantially identical to or similar to that of the boil-off gas and/or the addition of which to the boil-off gas does not adversely affect the intended use of the compressed boil-off gas.

The method according to the invention for the compression of boil-off gas produced in the storage of liquefied natural gas makes possible the withdrawal and compression of boil-off gas from an LNG or flat-bottomed tank operated at approximately atmospheric pressure without using a cold-intake machine, in that a precompression of the boil-off gas is effected by means of an ejector. The mode of operation according to the invention thus effectively avoids the risk of oxygen ingress into a flammable gas.

The pressure gain in the ejector is generally at least as high as the pressure drop over the heater connected downstream of the ejector and upstream of the compression and also over further plant components to be provided such as, for example, pipelines and fittings.

By using an ejector, comparatively expensive and maintenance-intensive moving parts can be dispensed with under cold operating conditions without risking unwanted and hazardous reduced-pressure states on the suction side of the warm-intake compressor to be provided for the compression.

Further advantageous embodiments of the method according to the invention for the compression of boil-off gas produced in the storage of liquefied natural gas include one or more of the following features:
the pressure elevation is between 50 and 500 mbar, preferably between 100 and 300 mbar,
at least temporarily, two different motive gases are fed to the ejector,
if the compressed boil-off gas is fed at least partially to a natural gas liquefaction process, at least one substream of a suitable process stream of the natural gas liquefaction process is used as motive gas, and/or
the boil-off gas, before compression thereof, is warmed by at least 80 K, preferably by at least 160 K.

If the preferred motive gas is not available in sufficient quantity and/or at sufficient pressure an additional or alternative motive gas can be used. This additional or alternative motive gas can be any gas (mixture), which arises within the liquefaction process and which is suitable for the intended purpose. For example, the liquefied and sub-cooled natural gas (LNG) is usually expanded and fed to a separator; while the liquid phase is routed to a storage tank (T), the gaseous phase can be used as (additional or alternative) motive gas.

The method according to the invention for the compression of boil-off gas produced in the storage of liquefied natural gas and further advantageous embodiments of the same will be described in more detail hereinafter with reference to the exemplary embodiment shown in FIG. 1.

### BRIEF DESCRIPTION OF THE DRAWINGS

Various other features and attendant advantages of the present invention will be more fully appreciated as the same becomes better understood when considered in conjunction with the accompanying drawing wherein:

FIG. 1 shows an embodiment according to the invention.

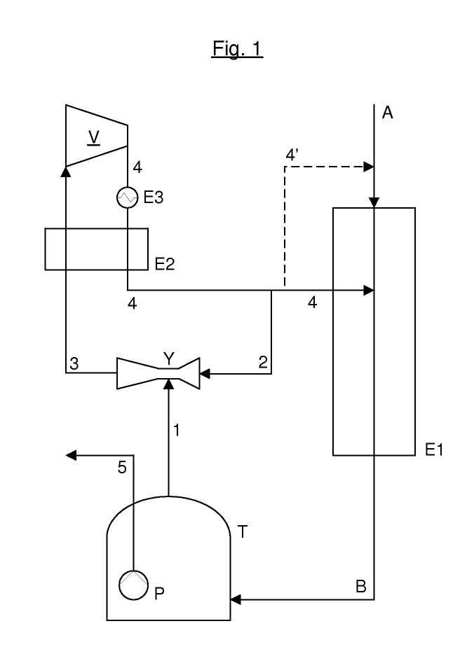

The exemplary embodiment depicted in FIG. 1 shows a natural gas liquefaction process in which the compressed boil-off gas is fed back to the natural gas stream A that is to be liquefied. This natural gas stream A is fed to a liquefaction process E1 which is depicted only as a black box. This liquefaction process E1 can be any desired liquefaction process which is used for the liquefaction and optionally subcooling of natural gas. The liquefied and optionally subcooled natural gas is withdrawn via line B from the liquefaction process E1 and fed to a storage tank T which is, for example, a flat-bottomed tank. Liquefied natural gas (LNG) is removed from this storage tank T via line 5 to which—if required—a pump P is assigned.

Boil-off gas produced in the storage tank T is withdrawn from the storage tank T via line 1 and fed to an ejector Y. A suitable motive gas, which will be considered in more detail hereinafter, is fed to this ejector Y via line 2. The boil-off gas that is to be compressed undergoes, in ejector Y, a pressure elevation between 50 and 500 mbar, preferably between 100 and 300 mbar.

The boil-off gas/motive gas mixture compressed in this manner—hereinafter called boil-off gas—is fed via line 3, after warming in the heater E2, to the boil-off gas compressor V that is designed as a single-stage or multistage type. In the heater E2, the boil-off gas 3 that is to be compressed is warmed against the compressed boil-off gas stream 4 by at least 80 K, preferably by at least 160 K. In the boil-off gas compressor V, compression proceeds to a pressure which is determined by the subsequent use of the boil-off gas.

If the compressed boil-off gas 4, as shown in FIG. 1, is fed back to the natural gas stream A that is to be liquefied, the boil-off gas must be compressed to at least the pressure of the natural gas stream A upstream of the liquefaction process E1. If, in contrast, the compressed boil-off gas is used as fuel gas, a lower pressure elevation can be sufficient, whereas other purposes of use may require a higher compression.

Downstream of the compression V, the boil-off gas is cooled in a heat exchanger E3 against air or cooling water, if the temperature of the boil-off gas downstream of the compression V is high enough therefor. This is always the case in the event of warming upstream of the compression to about ambient temperature, since the tank temperature is −160° C., the boil-off gas that is to be compressed is warmed, preferably by at least 160 K, and the suction temperature of the compressor V is therefore above 0° C.

In the present case, the compressed boil-off gas 4, after passage through the heater E2 in which it releases its (remaining) heat of compression to the boil-off gas stream 3 that is to be compressed, is fed to the natural gas stream A that is to be liquefied. In this case the compressed boil-off gas 4 can be fed to the natural gas stream A that is to be liquefied upstream of the feed thereof into the liquefaction process E1—shown by the dashed line 4′—and/or at a suitable temperature level of the liquefaction process El—depicted by the line 4.

According to the invention, in the exemplary embodiment depicted in FIG. 1, a substream 2 of the compressed boil-off gas 4 is fed to the ejector Y as motive gas. In principle, as motive gases, all gases can be used, the composition of which is substantially identical to or similar to that of the boil-off gas that is to be compressed and/or the addition of which to the boil-off gas does not adversely affect the intended use of the compressed boil-off gas.

If the compressed boil-off gas is to be used as fuel gas and an air fractionator is provided in the vicinity of the liquefaction process, the motive gas used for the ejector Y can also be a residual stream of this air fractionator. If, in the liquefaction process E1, a separation of heavy hydrocarbons is integrated, the separated, heavy hydrocarbon-rich stream can also be used as motive gas, if the compressed boil-off gas is not fed to the natural gas stream A that is to be liquefied.

Without further elaboration, it is believed that one skilled in the art can, using the preceding description, utilize the present invention to its fullest extent. The preceding preferred specific embodiments are, therefore, to be construed as merely illustrative, and not !imitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German Application No: 10 2011 110 004.4 , filed Aug. 11, 2011, are incorporated by reference herein.

1. A method for compression of boil-off gas produced in the storage of liquefied natural gas (LNG), said method comprising:
subjecting boil-off gas (1) that is to be compressed to a pressure elevation by means of at least one ejector (Y) using a motive gas (2),
then warming (E2) said boil-off gas, and
then compressing said boil-off gas (V) in a single-stage or multistage manner,
wherein said motive gas (2) used for the ejector (Y) is a substream of the compressed boil-off gas and/or a gas, the composition of which is substantially identical to or similar to that of the boil-off gas (1) and/or the addition of which to the boil-off gas does not adversely affect the intended use of the compressed boil-off gas.

2. The method according to claim 1, wherein said pressure elevation in said ejector is 50-500 mbar.

3. The method according to claim 2, wherein said pressure elevation in said ejector is 100-300 mbar.

4. The method according to claim 1, wherein, at least temporarily, two different motive gases are fed to the ejector (Y).

5. The method according to claim 1, wherein, after compressing said boil-off gas (V) in a single-stage or multistage manner, the compressed boil-off gas is fed at least partially to a natural gas liquefaction process, and at least one substream of said natural gas liquefaction process is used as said motive gas.

6. The method according to claim 1, wherein said boil-off gas is warmed by at least 80 K by said warming (E2) before said compression (V) in a single-stage or multistage manner.

7. The method according to claim 6, wherein said boil-off gas is warmed by at least 160 K by said warming (E2) before said compression (V) in a single-stage or multistage manner.

8. The method according to claim 1, wherein the warming of the boil-off gas before said compression (V) in a single-stage or multistage manner, is performed by heat exchanger with compressed boil-off gas.
